(19) United States
(12) Patent Application Publication
(10) Pub. No.: US 2009/0154718 A1
(43) Pub. Date: Jun. 18, 2009

(54) Method and apparatus for suppressor backfill

(76) Inventor: Steven R. Page, Naperville, IL (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/002,324

(22) Filed: Dec. 14, 2007

(51) Int. Cl. G10K 11/16

(52) U.S. Cl. 381/71.1

(57) ABSTRACT

In some communication applications, a near-end talker employs a cellular phone that either operates in a noisy environment and does not support artificial noise injection or injects noise but supports a simple, fixed noise injection. This may result in “blanking” of the background noise and result in repeated “are you still there?” questions or premature termination of a call. In order to prevent this feeling of “blanking,” a suppressor backfill module according to an example embodiment of the invention backfills those blank periods with noise, optionally in an inverse relationship with power of noise in a near-end signal, resulting in repairing sound quality degradation and giving a far end talker a feeling of call continuity. As a result, the near-end and far-end talker have a better experience during the call.

### BACKGROUND OF THE INVENTION

In order to maintain existing clients and attract new and additional customers, telephone service providers are interested in offering differentiating features to their services compared to other telephone service providers. A major differentiating feature is voice quality. In order to increase voice quality, telephone service providers are motivated to employ Voice Quality Enhancement (VQE) features, such as acoustic echo suppression and noise reduction.

Echo suppression provides enhanced voice quality in all types of calls delivered via telephony networks. Echo types generated in telephony networks include hybrid electronics echo (“hybrid echo”) and acoustic echo. Hybrid echo refers to electrically generated echo in a public-switched telephone network (PSTN). This type of echo is generated when voice signals transmitted via two-wire/four-wire PSTN conversion points (e.g., hybrid electronics) reflect their electrical energy from the four-wire points back to a microphone at a far end of the network. Acoustic echo is generated in both analog and digital handsets and is due to an acoustic coupling between a telephone earpiece and microphone. Acoustic echo occurs when the voice signal from a far-end talker makes its way from the telephone ear-piece to the microphone of near-end talker. In this case, the far-end talker hears an echo of his or her own voice signal that can be very distracting.

Another VQE function is a capability within the network to reduce any estimated or detected background noise on a call. Due to wide usage of background noise reduction, telephony system customers have grown accustomed to noise reduction services.

### SUMMARY OF THE INVENTION

A method or corresponding apparatus in an exemplary embodiment of the present invention generates an artificial noise signal by estimating power of noise on a near-end signal and detects signal suppression in the near-end signal. In an event signal suppression is detected, power of the artificial noise signal is adjusted based on an estimate of the power of the background noise on the near-end signal. The adjusted artificial noise signal is added to the near-end signal to produce an enhanced near-end signal, which is the output.

Additionally, an example embodiment of the present invention scales a backfill noise signal in an inverse relationship with power of noise in a near-end signal to produce a scaled backfill noise signal. The scaled backfill noise signal is inserted into the near-end signal in order to maintain background noise continuity.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a diagram of a telephone network that employs a suppressor backfill module (i.e. comfort noise injector) that backfills periods of silence with comfort noise;

FIG. 2 is a block diagram of a network that employs a suppressor backfill module using an example embodiment of the present invention;

FIGS. 3A-3E include signal diagrams illustrating operation of the suppressor backfill module on a signal;

FIG. 4 is a block diagram of an example embodiment of the suppressor backfill module;

FIGS. 5A-5B are detailed descriptions of the relationship between power of a near-end signal and a gain used to scale noise prior to injection in the signal path;

FIG. 6 is a detailed flow diagram of an example embodiment of the present invention;

FIG. 7 is a high level flow diagram of an example embodiment of the present invention;

FIG. 8 is a flow diagram of an example embodiment of the present invention.

### DETAILED DESCRIPTION OF THE INVENTION

A description of example embodiments of the invention follows.

Acoustic echo is at the root of some forms of sound quality degradation. Acoustic echo is generated in both analog and digital handsets and is due to an acoustic coupling between the earpiece and microphone. Generally, acoustic echo arises when sound from the ear-piece of a near-end telephone user makes its way back to the microphone. In such case, the far-end talker may hear an echo of himself or herself. The acoustic echo is very distracting because the path delay is substantial, allowing the returning voice of himself or herself to be shifted in the time to make returning voice detectable by his or her own ear; therefore, acoustic echo is preferably suppressed.

An example embodiment of the present invention relates to Voice Quality Enhancement (VQE) in telephony networks. In order to increase voice quality, telephone service providers are motivated to employ VQE features, such as acoustic echo suppression. In cellular communication, three techniques have been proposed to attempt to eliminate the acoustic echo. The first technique is to provide a large physical separation between the ear-piece and the microphone. This method, although impractical, provides ideal echo suppression. Having a large physical distance between the ear-piece and the microphone eliminates a possibility of having an acoustic echo, at least for handset-to-ear operating mode, and when there is no electrical echo present. Under such a setup, no further processing is required, and a full-duplex connection is maintained throughout the call. Another technique for eliminating acoustic echo is by providing electronic echo cancellation in the cell-phone circuitry. This will essentially eliminate the possibility of having an acoustic echo. Since, given this design, there will be no echo present, no further processing will be required and a full-duplex connection is maintained throughout the call. Third and possibly the most practical option for eliminating acoustic echo is by using a suppressor. The suppressor switches the communication to a one-way communication when speech is coming out of the cell-phone earpiece. This method is simple, effective, and can be implemented at a relatively low price and, hence, is widely used in telecommunications networks.

To perform acoustic echo suppression, the near-end cellular phone may suppress sound during far end speech. Under such a setup, the far-end talker hears silence when he speaks. When the far-end talker is silent, he either hears background noise or the near-end talker. This method, although effective, may result in repeated “are you still there?” questions or premature termination of the communication between the far-end and the near-end user. Specifically, in the latter case, since the far-end user hears silence when he speaks, he may assume that the communications link has been lost and may end the communication prematurely from his side. To deal with this problem, the system can mask the suppression by injecting noise instead of silence. In such case, the far-end talker hears the injected noise when he speaks or during periods of silence. Various methods may be employed to control the level and spectrum of the injected noise. Eliminating the silence is advantageous to the far-end talker because it eliminates the illusion of a dropped communications link and “are you still there?” questions or premature hang ups.

Under one embodiment of this invention, a method for repairing sound quality degradation caused by the gaps is introduced. Sound quality degradation may occur due to the gaps created by echo suppressors which are presently deployed in cellular telephones.

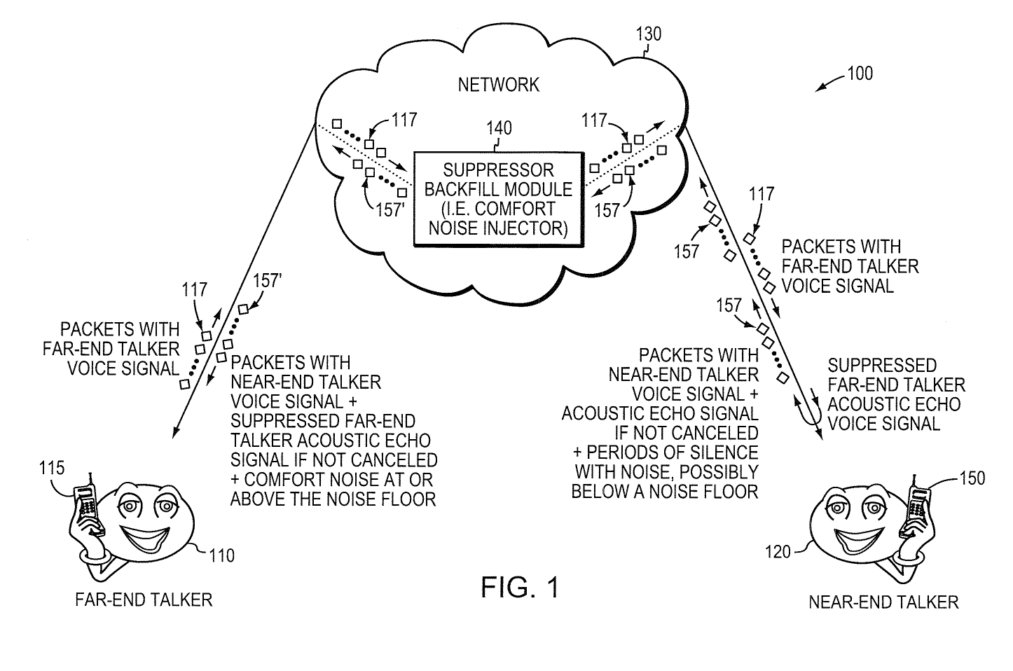

FIG. 1 illustrates an example telephony network 100 that employs a suppressor backfill module (i.e., comfort noise injector) 140. When the far-end talker 110 speaks, the far-end talker's cellular phone 115, in this scenario, sends out packets 117 containing a far-end talker voice signal to the network 130. In this example embodiment, a near-end talker 120 employs a cellular phone 150 that either operates in a noisy environment and does not have an artificial noise injector or injects noise but uses a simple, fixed noise injector. Because of the lack of a simple noise injector, the far-end talker 110, in an absence of the suppressor backfill module 140, may hear a disconcerting “blanking” of the background noise, which may lead the far-end talker 110 to believe that the near end talker 120 is no longer there and ask “are you still there?” or end the call prematurely.

In operation, the network 130 carries the far-end talker acoustic signal packets 117 to the near-end talker 120. The cellular phone 150 of the near-end talker 120 in turn cancels an acoustic echo signal of the far-end talker voice signal. If the echo signal has not been completely cancelled, the cellular phone 150 of the near-end talker 120 may suppress remaining acoustic echo of the far-end talker 110 and transmit packets 157 of the suppressed far-end talker when the near-end talker 120 acoustic voice signal is quiet, or transmits unsuppressed packets 157 when the near-end talker 120 is speaking. In cases where a suppression in the far-end signal is detected (performed by the cellular phone 150), an artificial noise injection module (not shown) of the cellular phone 150 adds some comfort noise into or in place of the suppressed acoustic echo. When the cellular phone 150 operates in a noisy environment or when it does not include an artificial noise generator/injection module, the network 130, according to this example embodiment of the invention, employs the suppressor backfill module 140 to add comfort noise to the transmitted packets 157 and compensate for the insufficient amount of comfort noise.

The suppressor backfill module forwards 140 modified communication packets 157′ with near-end talker voice signal or suppressed far-end talker acoustic echo signal and the injected comfort noise to the cellular phone 115 of the far-end talker 110. In this case if the near-end talker 120 is silent, the far-end talker receives the suppressed far-end talker acoustic echo signal along with the injected comfort noise, which has an effect on the far-end talker 110 that the call remains active even when the near-end cellular phone is sending silence.

In accordance with the foregoing, a method or corresponding apparatus in an example embodiment of the present invention generates an artificial noise signal by estimating power of noise on a near-end signal and detects signal suppression in the near-end signal. In an event signal suppression is detected, power of the artificial noise signal is adjusted based on an estimate of the power of the background noise on the near-end signal. The adjusted artificial noise signal is added to the near-end signal to produce an enhanced near-end signal, which is the output.

Another example embodiment of the present invention scales a backfill noise signal in an inverse relationship with power of noise in the near-end signal to produce a scaled backfill noise signal. The scaled backfill noise signal is inserted into the near-end signal in order to maintain background noise continuity.

In the view of the foregoing, the following description illustrates example embodiments and features that may be incorporated into a system for controlling echo in the coded domain, where the term “system” may be interpreted as a system, a subsystem, apparatus, method or any combination thereof.

In order to repair sound quality degradation, the system may estimate power of noise on a near-end signal, generate an artificial noise signal based on an estimate of power of noise on the near-end signal, detect signal suppression in the near-end signal, adjust power of the artificial noise signal based on an estimate of the power of the background noise on the near-end signal in an event signal suppression is detected, add the artificial noise signal in an adjusted state to the near-end signal to produce an enhanced near-end signal, and output the enhanced near-end signal.

The system may generate the artificial noise signal by matching spectral bands in the artificial noise signal to spectral bands of actual background noise in the near-end signal.

The system may generate the artificial noise signal by recording and outputting actual background noise in the near-end signal in a time shifted manner.

The system may adjust power of the artificial noise signal in a non-linear manner at a noise floor defined as a minimum acceptable power level of noise across at least one spectral range in the near-end signal.

The system may adjust gain of the artificial noise to maintain background noise continuity in the adjusted near-end signal.

The system may detect signal suppression in the near-end signal by comparing power of the near-end signal against a threshold and indicating signal suppression in an event the power of the near-end signal falls below the threshold. The threshold may represent power of the background noise on the near-end signal during an absence of signal suppression.

The system may adjust the power of the artificial noise signal by calculating a gain with which to adjust the power of the artificial noise signal in an inverse relationship with power of noise in the input signal, and multiplying the artificial noise signal by the gain.

The system may maintain background noise continuity by first scaling a backfill noise signal in an inverse relationship with power of noise in a near-end signal to produce a scaled backfill noise signal and second inserting the scaled backfill noise signal into the near-end signal.

The system may scale the backfill noise signal by multiplying the backfill noise signal by a gain having a value between zero and one according to a power curve having a negative slope between zero and power of background noise on the near-end signal determined during a non-voice activity period.

The system may scale the backfill noise signal by multiplying the backfill noise signal by a gain calculated to ensure power of the scaled backfill noise signal, in combination with power of the near-end signal, is at or exceeds a noise floor.

The system may estimate the power of noise on the near-end signal by enabling the estimating during an absence of voice on the near-end signal and a far-end signal.

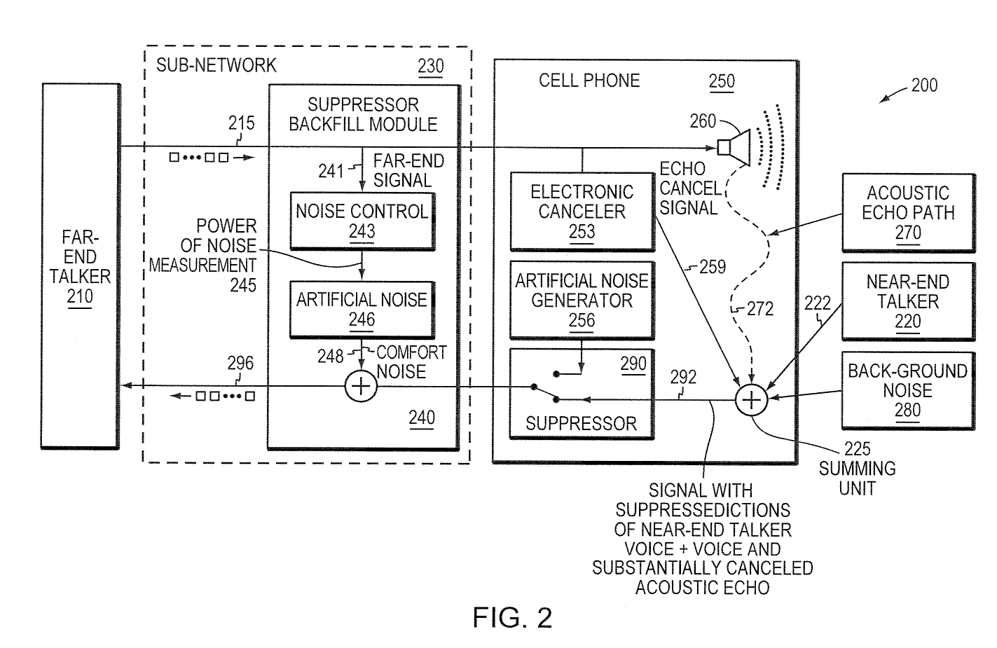

FIG. 2 is a network diagram of a network 200 that employs a suppressor backfill module 240, in a sub-network 230, using an example embodiment of the present invention. The suppressor backfill module 240 is placed in the sub-network 230, connecting a far-end talker 210 and a near-end talker 220. The suppressor backfill module 240 protects the far-end talker 210 from disconcerting gaps in sound due to suppressed acoustic echoes. In this example embodiment, the near-end talker employs a cellular phone 250 that either operates in a noisy environment and does not support artificial noise injection or injects noise but supports a simple, fixed noise injection. Under such conditions, the far-end talker 210 may hear a disconcerting “blanking” of the background noise, which may lead the far-end talker 210 to believe that the near end talker 220 is no longer there and end the communication (i.e. call) prematurely or may lead the far-end talker 210 to ask “are you still there?”. In order to prevent this from happening, the suppressor backfill module 240 backfills those blank periods with noise, resulting in repairing sound quality degradation and giving the far end talker 210 a feeling of call continuity.

Representations of the acoustic signal 215 (e.g. voice) of the far-end talker 210 is transmitted through the sub-network 230 to the cellular telephone 250 of the near-end talker 220. In this example network 200, in the cellular phone 250 of the near-end talker 220, an electronic canceller 253 is employed. The electronic canceller 253 receives the representations of the acoustic signal 215 from the far-end talker 210 and is responsible for cancelling any echo of the representations of the acoustic signal 215 in a signal to be transmitted to the far-end talker 210. The electronic canceller 253 may take into account factors, such as absence or presence of double talk during its operation. The resulting echo cancel signal 259 is subsequently transmitted to a summing unit 225 of the cellular phone 250 of the near-end talker 220, which also receives electrical representations of acoustic path echo 272, via an acoustic echo path 270, voice of the near-end talker 220, and background noise 280. The echo cancel signal 259 is thus intended to cancel representations of the acoustic echo 272 to result in a signal 292, with representations of the near-end talker 220 and noise with substantially cancelled echo.

The suppressor backfill module 240 of the sub-network 230 takes in far-end signal 241 corresponding to the representations of the far-end talker 210 acoustic signal 215. The backfill module 240 contains a noise control module 243 that measures the power of noise in the far-end signal 241 and a near-end signal 242. Based on this measurement 245, an artificial noise generator 246 generates or adjusts comfort noise 248.

The representations of the acoustic signal 215 from the far-end talker 210 arrives at the ear-piece 260 of the cellular telephone 250 of the near-end talker 292. Because the ear-piece 260 and the microphone (not shown) of the cellular telephone 250 of the near-end talker 220 are placed physically close to one another, the representations of the acoustic signal 215 from the far-end talker 210 may be delivered from the ear-piece 260 to the microphone of the cellular telephone 250. In FIG. 2, the representations of the acoustic echo signal 215 of the far-end talker 210 is transmitted via the acoustic echo path 270.

In cases where the near-end talker 220 is not silent, the acoustic signal 222 from the near-end talker 220 is also delivered to the microphone. Regardless of whether the near-end talker 220 is talking or silent, there may be an unknown amount of acoustic background noise 280 available in the environment of the near-end talker 220. This acoustic background noise 280 is also delivered to the microphone of the cellular telephone 250 of the near-end talker 220.

The suppressor module 290 of the cellular telephone 250, when activated, suppresses any remaining acoustic echo that has not been cancelled. The cellular telephone 250 of the near-end talker 220 may also include an artificial noise generating module 256. This module 256 is responsible for generating and injecting artificial noise into the suppressed near-end signal. As shown in FIG. 2, artificial noise 256 injection only takes place when signal suppression in the near-end signal (e.g., acoustic echo of the far-end talker 210) is detected.

In cases when the cellular telephone 250 operates in a noisy background and there is an excessive amount of background noise 280, the added artificial noise 256 may not be sufficient to compensate for the amount of suppression performed in the suppressor module 290. Also, in some cases, the cellular telephone 250 does not include the modules used to inject artificial noise. There is also the possibility that the cellular telephone 250 includes noise injection means but employs simple fixed-noise injection algorithms. In such cases, the added artificial noise 256 may not be sufficient to compensate for the amount of suppression performed in the suppressor module 290. This can result in the far-end talker 210 hearing disconcerting blanking of the background noise. To deal with such situations, the suppressor backfill module 240 backfills these blank periods with artificial noise (e.g. generated, synthesized, or recorded), giving the far-end talker a feeling of continuity of the call.

The near-end signal 292, potentially containing suppressed far-end talker 210 acoustic echo 272, cancelled echo 259 from the electric echo canceller 253, and background noise 280, enters the suppressor backfill module 240. This near-end signal 292 is delivered to the noise control module 243, where the power of noise on the near-end signal is estimated. Based on the estimated power of noise on the near-end signal 292, the artificial noise module 246 may generate artificial comfort noise.

If no suppression of echo signal in the near-end signal 292 is detected, the backfill module 240 injects no comfort noise 248 into the incoming signal 292 and subsequently delivers the resulting signal 296 to the far-end talker 210, and in this case the resulting signal 296 is identical to the near-end signal 292.

In an event signal suppression is detected, the backfill module 240 adjusts the power of the generated artificial noise (generated artificial noise module 246) based on the estimate of power of noise on the near-end signal 292. The resulting adjusted artificial noise 248 is then added to the near-end signal 292 to produce an enhanced near-end signal 296. The resulting enhanced signal 296 is the output of the backfill module 240, which is delivered to the far-end talker 210.

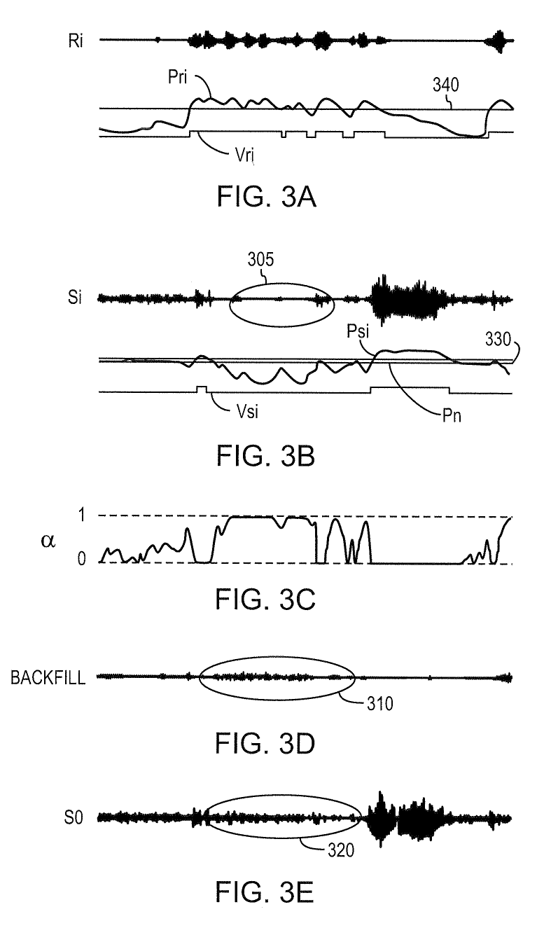

FIGS. 3A-3E are signal diagrams illustrating the operation of an example suppressor backfill module on a signal. The circled area 305 in the plot of FIG. 3B, which demonstrates a spectrum of the near-end signal Sᵢ, illustrates a gap inserted by a suppressor of a cellular telephone in the near-end signal Sᵢ. This is in spite of the fact that there is energy on the far-end signal Ri.

The value of noise gain function parameter α of FIG. 3C increases from 0.0 toward 1.0 when the power of the near-end signal Psi drops below a noise floor Pn. The dotted lines 330, 340 with Pri (power of the far-end signal) and Psi are the VAD (Voice Activity Detector) thresholds, such that power levels above the dotted lines 330, 340 are considered voice.

Comparison of the So signal of FIG. 3E to the Si signal of FIG. 3A shows that the backfill module has effectively filled-in the gaps in the background noise, and provided the desired continuity in the signal.

FIG. 3E illustrates a case where the suppressor backfill has backfilled the gap in the spectrum of the near-end signal Sᵢ (gap 305 shown in FIG. 3B) by injecting the artificial noise of FIG. 3D. As is clear from FIG. 3E, the backfill module has filled in the gap 305 in the spectrum of the near-end signal Sᵢ by injecting the artificial noise of FIG. 3D. The injection of the artificial noise has filled in the gap 305, resulting in filling that region 320 of the signal and creating a feeling of continuity when listening to the near-end signal Sₒ.

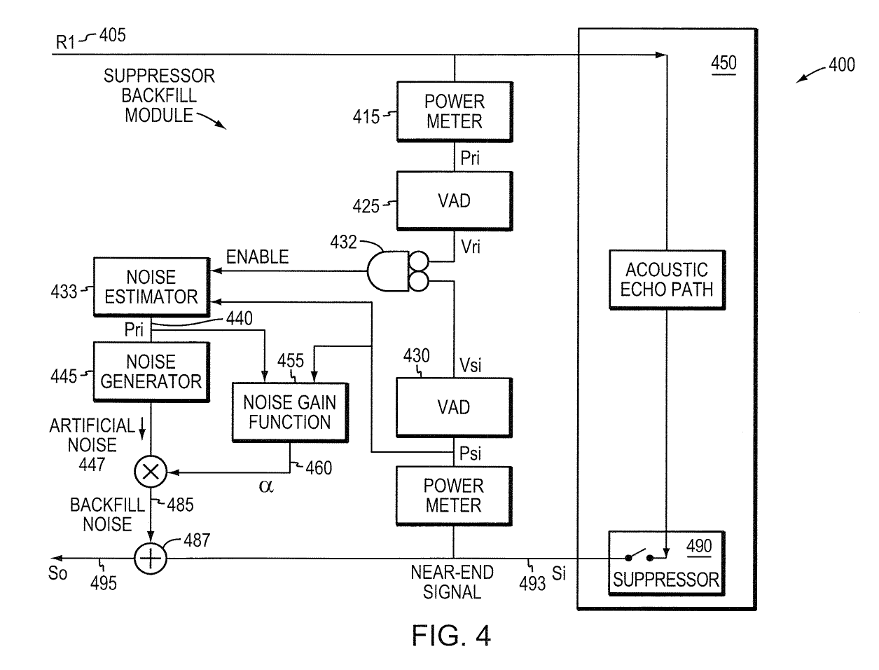

FIG. 4 illustrates a block diagram of an example embodiment of a suppressor backfill system 400 (send-in Sᵢ). The backfill system 400 injects backfill noise 485 into the near-end signal (send-in Sᵢ) 493 at such a level so as to prevent a perception of a broken voice path. The perception of a broken voice path may be caused by the suppression of the far-end acoustic echo in the suppressor 490 of the cellular telephone 450. The backfill system 400 may operate by generating an artificial background noise that matches the spectral content and level of the actual background noise in the near-end signal 493 and adjusting gain 455 of the artificial noise to maintain background continuity in the adjusted near-end signal 495.

The backfill system 400 may estimate the noise level on the near-end signal 493 coming from the cellular phone 450 of the near-end talker. In this example embodiment, a logic function 432 classifies the near-end signal 493 as one of two categories: noise signal or other. The category “other” includes suppression, speech from the far-end talker 210 and speech from the near-end talker 220. During the time logic function 432 classifies the near-end signal 493 as noise, the noise estimator 433 measures the characteristics of the Sᵢ 493. Suppression is the case when the suppressor 490 of the cellular phone 450 is outputting a signal that has a lower power than that of the background noise. In order to detect suppression, the backfill system 400 of this example embodiment compares the power of the near-end signal 493 against a threshold and indicates signal suppression in an event the power of the near-end signal falls below the threshold. This threshold represents the power of the background noise on the near-end signal 493 during an absence of signal suppression.

In one example embodiment, the noise estimator 432 is enabled only when both voice activity detectors (VAD) 425, 430 indicate that there is no voice activity in either direction. This situation may occur when both the near-end talker and the far-end talker are silent. The lack of voice activity on both ends of the communication indicates that there is no voice signal on the near-end signal 493, and, hence, the cellular telephone 450 does not activate its suppressor 490.

In the absence of voice activity from both sides of the communication, the noise estimator 435 measures the level of background noise. The output Pn 440 of the noise estimator 435 in such a case is a measure of the background noise. The noise estimator 435 may additionally provide a spectral estimate of the noise. Given a spectral estimate of the background noise, the noise generator module 445 can provide a spectral estimate that sounds as similar to the actual noise background as possible.

The backfill system 400 may provide the estimated measure of background noise and any available spectral information (i.e. Pn 440) to the noise generator block 445. Based on this information Pn 440, the noise generator module 445 generates or otherwise produces artificial noise. The generation or other production of artificial noise 447 by the noise generator module 445 may be performed based on recording and outputting a time-shifted version of the actual background noise, by calculations, random number generation, or other techniques known for generating white or pink (e.g., spectrally weighted) noise.

A noise gain function parameter α 460 throttles the noise injection process such that enough noise is injected to ensure that the power of a modified near-end signal 495 derived from the near-end signal 493 never drops below the background noise level Pₙ 440. The parameter 460 is multiplied by the artificial noise 447 by a multiplier 448 to produce the backfill noise 485, which is added to the near-end signal 493 by a summing unit 487 to produce an enhanced near-end (send-out (Sₒ)) signal 495.

The backfill system 400 adjusts the power of the injected artificial noise to ensure that the power of the injected artificial noise never drops below the noise floor of the background noise. The backfill system 400 adjusts the power of the injected artificial noise by calculating the gain, α 460, according to which the power of the artificial noise is adjusted. This gain 460 may be calculated based on an inverse relationship with power of noise in the input signal. The artificial noise signal 447 is then multiplied by the calculated gain 460 and inserted into the near-end signal 493 to create an enhanced near-end signal 495.

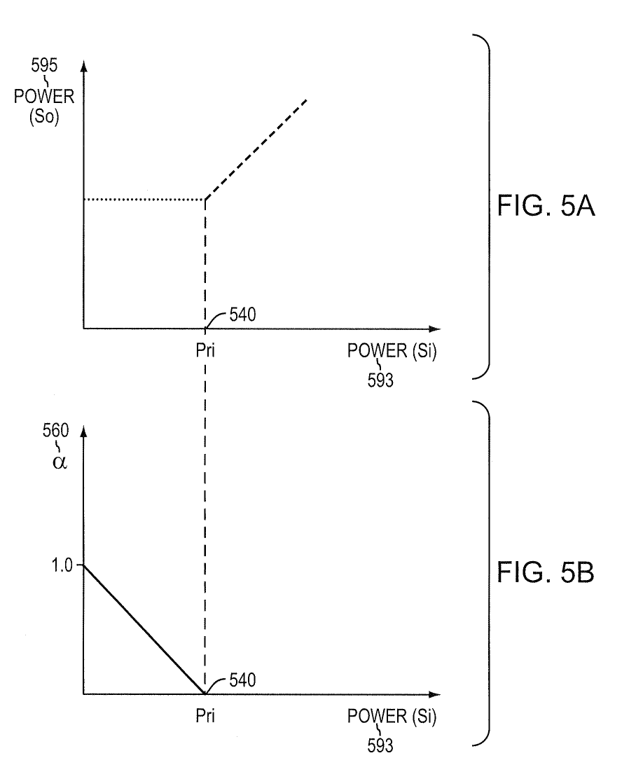

FIG. 5A is a graph that illustrates a relationship between power of near-end signal Sᵢ and power of enhanced near-end signal Sₒ with respect to a background noise level Pₙ. As demonstrated by the graph, when the power of the near-end signal 593 is greater than the background noise level Pₙ, the power of the near-end signal 593 and the power of the enhanced near-end signal 595 may maintain a linear relationship. Additionally, when the power of the near-end signal falls below the background noise level Pₙ, the noise gain function parameter α inversely increases from zero to one, and the enhanced near-end signal 595 is caused to stay at the same level at or above a noise floor.

FIG. 5B is a graph that illustrates an example relationship between the noise gain function parameter α and the power of the near-end signal 593. As the power of the near-end signal 593 increases, the value of the noise gain function parameter α decreases. Similarly, when the power of the near-end signal 593 falls below the background noise level Pₙ towards zero, the value of α increases. This effectively backfills the gaps that the suppressor of the cellular telephone has introduced into the background noise.

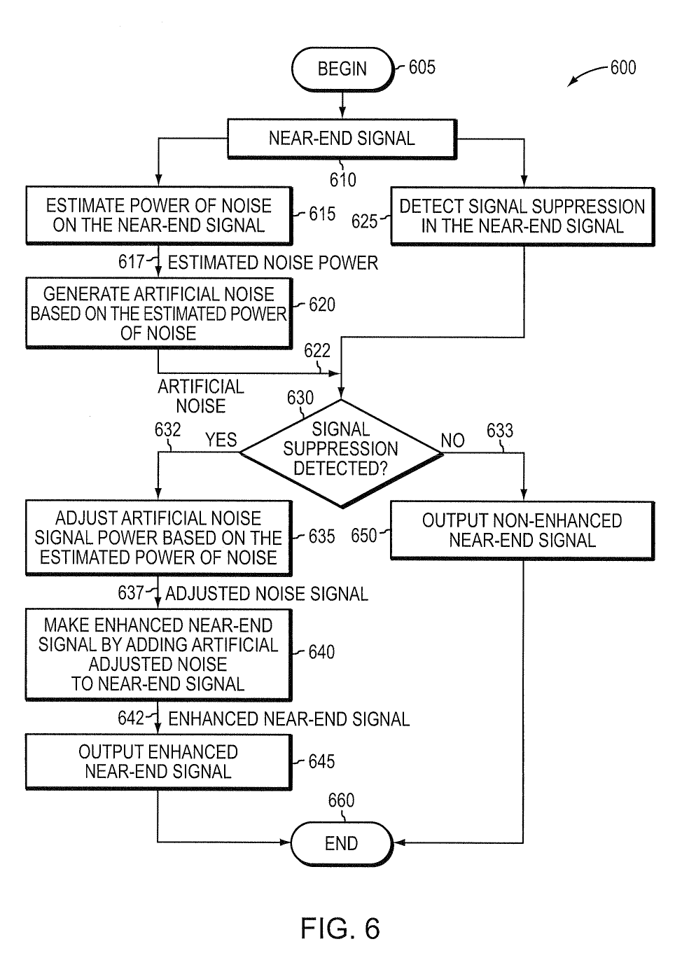

FIG. 6 is a detailed flow diagram 600 of an example embodiment of the present invention. The example embodiment takes a near-end signal 610 containing the acoustic signal from near-end microphone, acoustic echo if not already cancelled, as well as background noise or periods of silence. In block 615, the example embodiment measures the power of noise on the near-end signal 610. Based on the estimated power of noise 617, block 620 of the example embodiment generates an artificial noise 622. Block 625 checks for signal suppression in near-end signal. If signal suppression is detected 632, block 635 of the example embodiment adjusts the generated artificial noise signal 622 based on the estimated power 617 of the near-end signal 610. Block 640 of the example embodiment, subsequently, injects the adjusted noise signal 637 into the near end signal to generate an enhanced near-end signal 642. The enhanced near-end signal is then outputted 645 to the far-end talker.

If signal suppression is not detected (633), the system outputs a non-enhanced near-end signal 650 to the far-end talker.

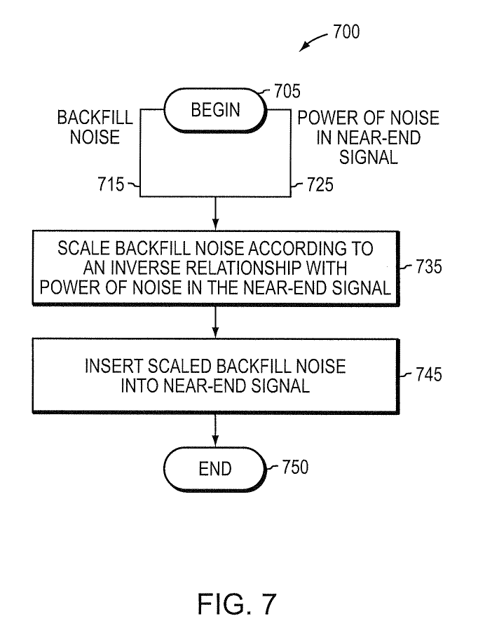

FIG. 7 is a high-level flow diagram 700 of an example embodiment of the present invention. The example embodiment inputs backfill noise 715 along with power of noise in the near-end signal 725. In block 735, the example embodiment scales the backfill noise according to an inverse relationship with power of noise in the near-end signal. In block 745, the scaled backfill noise is inserted into the near-end signal to generate an enhanced near-end signal.

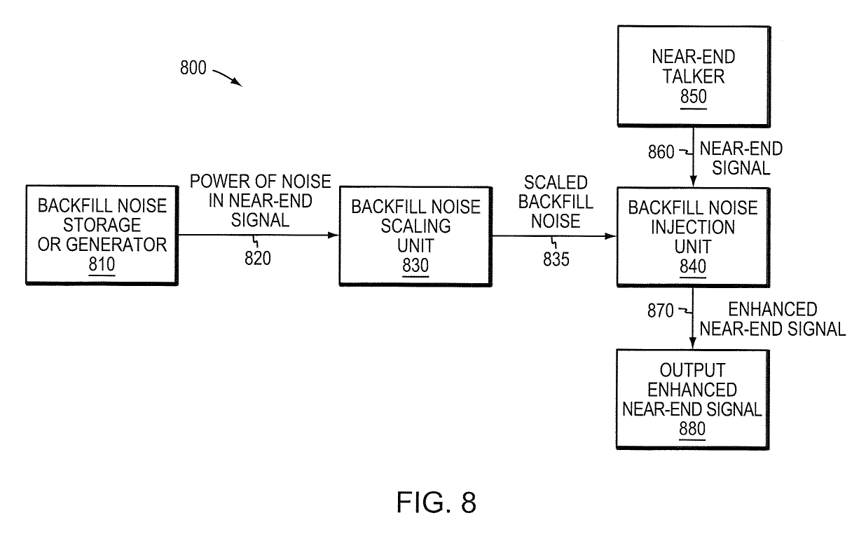

FIG. 8 is a block diagram 800 of an example embodiment of the present invention. The example embodiment acquires a backfill noise from a backfill noise storage or generator. Based on a prior knowledge of power of noise in a near-end signal 820, the backfill noise scaling unit 830 scales the backfill noise to produce a scaled backfill noise 835. The power of noise in the near-end signal 820 may be estimated by the system or provided to the system by an outside source. The scaled backfill noise 835 subsequently enters a backfill noise injection unit, where it is injected into the near-end signal 860, representing speech, for example of a near-end talker 850, to produce an enhanced near-end signal 870. Block 880 of the example embodiment outputs the enhanced near-end signal.

While this invention has been particularly shown and described with references to example embodiments thereof, it will be understood by those skilled in the art that various changes in form and details may be made therein without departing from the scope of the invention encompassed by the appended claims.

What is claimed is:

1. A method for repairing sound quality degradation, comprising
estimating power of noise on a near-end signal;
generating an artificial noise signal based on an estimate of power of noise on the near-end signal;
detecting signal suppression in the near-end signal;
adjusting power of the artificial noise signal based on an estimate of the power of the background noise on the near-end signal in an event signal suppression is detected;
adding the artificial noise signal in an adjusted state to the near-end signal to produce an enhanced near-end signal; and
outputting the enhanced near-end signal.

2. The method of claim 1 wherein generating the artificial noise signal includes matching spectral components in the artificial noise signal to spectral components of actual background noise in the near-end signal.

3. The method of claim 1 wherein generating the artificial noise signal includes recording and outputting actual background noise in the near-end signal in a time shifted manner.

4. The method of claim 1 wherein adjusting power of the artificial noise signal is non-linear at a noise floor defined as a minimum acceptable power level of noise across at least one spectral range in the near-end signal.

5. The method of claim 1 further comprising adjusting gain of the artificial noise to maintain background noise continuity in the adjusted near-end signal.

6. The method of claim 1 wherein detecting signal suppression in the near-end signal includes:
comparing power of the near-end signal against a threshold; and
indicating signal suppression in an event the power of the near-end signal falls below the threshold.

7. The method of claim 6 wherein the threshold represents power of the background noise on the near-end signal during an absence of signal suppression.

8. The method of claim 1 wherein adjusting the power of the artificial noise signal includes:
calculating a gain with which to adjust the power of the artificial noise signal in an inverse relationship with power of noise in the input signal; and
multiplying the artificial noise signal by the gain.

9. The method of claim 1 wherein estimating the power of noise on the near-end signal includes enabling the estimating during an absence of voice on the near-end signal and a far-end signal.

10. An apparatus for repairing sound quality degradation, comprising
an estimation unit to estimate power of noise on a near-end signal;
an artificial noise signal generation unit to generate an artificial noise signal based on an estimate of noise on the near-end signal;
a detection unit to detect signal suppression in the near-end signal
an adjustment unit to adjust artificial power of the noise signal based on an estimate of the power of the background noise on the near-end signal in an event signal suppression is detected;
a summation unit to add the artificial noise signal in an adjusted state to the near-end signal to produce an enhanced near-end signal; and
an outputting unit to output the enhanced near-end signal.

11. The apparatus of claim 10 wherein the artificial noise signal generation unit is configured to generate the artificial noise signal based on matching spectral components in the artificial noise signal to spectral components of actual background noise in the near-end signal.

12. The apparatus of claim 10 wherein the artificial noise signal generation unit is configured to generate the artificial noise signal based on recording and outputting actual background noise in the near-end signal in a time shifted manner.

13. The apparatus of claim 10 wherein the adjusted power of the artificial noise signal in the adjustment unit is non-linear at a noise floor defined as a minimum acceptable power level of noise across at least one spectral range in the near-end signal.

14. The apparatus of claim 10 wherein the adjustment unit includes a gain adjustment unit to adjust gain of the artificial noise to maintain background 20 noise continuity in the adjusted near-end signal.

15. The apparatus of claim 10 wherein the detection unit is configured to detect signal suppression in the near-end signal based on comparing power of the near-end signal against a threshold and to indicate signal suppression in an event the power of the near-end signal falls below the threshold.

16. The apparatus of claim 15 wherein the threshold represents power of the background noise on the near-end signal during an absence of signal suppression.

17. The apparatus of claim 10 wherein the adjustment unit is configured to adjust artificial power of the noise signal based on calculating a gain with which to adjust the power of the artificial noise signal, in an inverse relationship with power of noise in the input signal; and
wherein the adjustment unit further includes a multiplier to multiply the artificial noise signal by the gain.

18. The method of claim 10 further including logic to enable the estimation unit to estimate the power of noise on the near-end signal during an absence of voice on the near-end signal and a far-end signal.

19. A computer program product comprising a computer readable medium having computer readable code stored thereon, which, when executed by a processor, causes the processor to:
estimate power of noise on a near-end signal;
generate an artificial noise signal based on the estimate of noise on the near-end signal;
detect signal suppression in the near-end signal;
adjust artificial power of the noise signal based on an estimate of the power of the background noise on the near-end signal in an event signal suppression is detected;
add the artificial noise signal in an adjusted state to the near-end signal to produce an enhanced near-end signal, and
output the enhanced near-end signal.

20. A method for maintaining background noise continuity, comprising:
scaling a backfill noise signal in an inverse relationship with power of noise in a near-end signal to produce a scaled backfill noise signal; and
inserting the scaled backfill noise signal into the near-end signal.

21. The method of claim 20 wherein scaling the backfill noise signal includes multiplying the backfill noise signal by a gain having a value between zero and one according to a power curve having a negative slope between zero and power of background noise on the near-end signal determined during a non-voice activity period.

22. The method of claim 20 wherein scaling the backfill noise signal includes multiplying the backfill noise signal by a gain calculated to ensure power of the scaled backfill noise signal, in combination with power of the near-end signal, is at or exceeds a noise floor.

23. An apparatus for maintaining background noise continuity, comprising:
a signal adjustment unit to scale a backfill noise signal in an inverse relationship with power of noise in a near-end signal to produce a scaled backfill noise signal; and
an insertion unit to insert the scaled backfill noise signal into the near-end signal.

24. The method of claim 23 further including a power meter to determine the power of the noise on the near-end signal and wherein the signal adjustment unit includes a multiplier and is configured to scale the backfill noise signal by multiplying the backfill noise signal by a gain having a value between zero and one according to a power curve having negative slope between zero and power of background noise on the near-end signal determined during a non-voice activity period.

25. The method of claim 23 wherein the signal adjustment unit includes a multiplier and is configured to scale the backfill noise signal by multiplying the backfill noise signal by a gain calculated to ensure power of the scaled backfill noise signal, in combination with power of the near-end signal, is at or exceeds a noise floor.
